(19) United States
(12) Patent Application Publication
(10) Pub. No.: US 2004/0020110 A1
(43) Pub. Date: Feb. 5, 2004

(54) Multiple transplanting apparatus

(75) Inventor: Albertus Jacobus Van Voorthuizen, Puttershoek (NL)

Correspondence Address: BANNER & WITCOFF, 1001 G STREET N W, SUITE 1100, WASHINGTON, DC, 20001, US

(73) Assignee: Visser' s-Gravendeel Holding B.V., 's-Gravendeel (NL)

(21) Appl. No.: 10/446,157

(22) Filed: May 28, 2003

(30) Foreign Application Priority Data
Jan. 30, 2002 (NL) 1019870

(51) Int. Cl. A01G 9/00

(52) U.S. Cl. 47/1.01 P

(57) ABSTRACT

Apparatus for transplanting plants from containers with small cavities to containers with large cavities, comprising:

first transport means for supplying and removing containers with small cavities;

second transport means for supplying and removing containers with large cavities;

a moving and gripping apparatus with a first movable gripper for gripping the plants in the container with the small cavities, transporting the plant to the containers with the large cavities and locating the plants in the large cavities, wherein the moving and gripping apparatus comprises at least a second gripper, and the first and the at least second gripper have located on the same carrier, which carrier is movable between a position above the first transport means and a position above the second transport means.

### FIELD OF THE INVENTION

The invention relates to an apparatus for transplanting plants from containers with small cavities to containers with large cavities, comprising first transport means for supplying and removing containers with small cavities; second transport means for supplying and removing containers with large cavities; a moving and gripping apparatus with a first movable gripper for gripping the plants in the container with the small cavities, transporting the plant to the containers with the large cavities and locating the plants in the large cavities.

### BACKGROUND OF THE INVENTION

Such a transplanting apparatus is known from the Dutch patent application no. 8802151, filed Aug. 31, 1988, to Visser 's-Gravendeel Holding B. V., the entire disclosure therein being incorporated by reference herein.

These apparatuses are used during the transplanting of plants from a first container to a second container.

During the growth of the plants, the size of the plant increases, both in and above the soil or substrate. After some time the plant must be transplanted into a larger container. This could be from a tray with a large number of small cavities to a tray with less, but larger cavities, or from a tray to a pot.

With the increase of automation in horticulture there is an increased need to a larger capacity for transplanting.

### BRIEF DESCRIPTION OF THE INVENTION

The aim of the invention is provision of such a transplanting apparatus with a larger capacity.

This aim is reached in that the moving and gripping apparatus comprises at least a second gripper, and the first and the at least second gripper have been located on the same carrier, which carrier is movable between a position above the first transport means and a position above the second transport means.

The application of more than one gripper allows to increase considerably the capacity of such a transplanting machine.

Another advantage resides in the price. According to the present invention only a single extra gripper should be used together with the related control, so that twice the capacity is obtained with little extra costs.

According to a first embodiment the first transport means have been adapted for supplying containers with small cavities with a first pitch between the containers; the second transport means have been adapted for supplying containers with large cavities with the second pitch between the containers; and wherein the distance between the first gripper and the second gripper equals the first pitch.

The application of these features makes the distance between the plants equal during the gripping in the first containers until the position in the second containers. This obviates means for amending the mutual distance, which would otherwise be necessary during the transplant between the containers.

Another preferred embodiment teaches that the distance between the first and the second gripper is adaptable. This allows the plants from the containers with a certain pitch to be supplied to containers with another pitch. This pitch can relate on the pitch between the mutual containers, but also on the pitch between the cavities within the containers. It will be clear that also in this embodiment the number of grippers can be larger than two, although the number of four grippers anid more may lead to complicated constructions.

According to a more specific embodiment the first transport means have been adapted for supplying containers with more than one cavity per container, and second transport means have been adapted to supply containers with only one cavity per container.

This embodiment is especially applicable for the transplanting of plants from trays to pots.

To further increase the capacity, another embodiment proposes to provide the moving and gripping apparatus with at least a third gripper, in which the first, second and at least third gripper are located on a single line, and in which the distance between the second gripper and the at least third gripper is equal to the first pitch.

Yet another embodiment teaches that the first transport means have been adapted to supply containers with little cavities with a second pitch between the cavities, and wherein the second transport means have been adapted for supplying the containers with a second pitch between the containers, and wherein the distance between the first and the second gripper equals this second pitch.

This embodiment relates to situations in which the plants should be transplanted from containers with a large density of cavities to containers with a smaller density of cavities.

Also in this situation the capacity of the apparatus can be increased when the moving and gripping apparatus comprises at least a third gripper, in which the first, second and at least third gripper are located on a single line and in which the distance between the second and at least third gripper equals the second pitch.

Although numerous constructions, like a robot, are possible to implement the apparatus according to the embodiment, it is attractive when the direction of transport of both transport means extends parallel, the carrier comprises a longitudinal element on which the grippers have been provided, and, when the carrier is movable substantially perpendicular to the direction of transport of the transport means.

A substantial flexibility is obtained when the apparatus comprises a gantry construction of which the legs are located at both sides of the transport means, and wherein the carrier is movably connected to the horizontal part of the gantry construction.

### BRIEF DESCRIPTION OF THE DRAWINGS

Subsequently the present invention will be elucidated with the help of the accompanying figures wherein:

FIG. 1 is a perspective diagrammatic view of a first embodiment of the apparatus according to the present invention;

FIG. 2 is a schematic plan view of the embodiment depicted in FIG. 1;

FIG. 3 is a plan view from a further embodiment;

FIG. 4 is a plan view from yet another embodiment; and

FIG. 5 is a plan view of a last embodiment.

### DETAILED DESCRIPTION OF THE INVENTION

The apparatus according to the present invention comprises a conveyor belt one for supplying trays 2. The trays 2 each have a rectangular configuration of cavities 3 wherein plants 4 have been located.

Further the apparatus comprises a turntable 5 as is described in the Dutch patent application no. 1012438, filed Jun. 25, 1999, to Visser 's-Gravendeel Holding B. V., the entire disclosure therein being incorporated by reference herein.

This turntable comprises clamps 6, wherein flowerpots 7 have been located. These flowerpots have already been filled with soil or a substrate 8. The room available for the plants for in the pot 7 is much larger than the available room in the trays 2. The apparatus according to the invention serves for transplanting the plants 4 from the cavities 3 in the two trays 2 towards the pots 7.

Use is made of a transplanting element which is generally indicated as 9, and which comprise a gantry-shaped frame 10, in which a cross-beam 11 has been provided. The cross-beam 11 is movable in the direction perpendicular to the direction of transport of the conveyor belt 1 and the turntable along the upper side of the gantry-like construction 10. At both sides of the cross-beam 11 grippers 12 have been provided. The construction of the grippers 12, not the subject of the present application, is completely disclosed in the previously referenced Dutch patent application no. 8802151. Furthermore, it is possible to apply other gripper constructions in the present invention.

The operation of the apparatus according to the 5 invention is as follows.

The gripper constructions 12 are above the trays, and indeed above two plants 4 in the position drawn. These grippers grip the plants 4 at their balls, remove these from the cavities 3 and move these upwardly. The construction needed therefore also forms part of the grippers concerned.

Subsequently the cross-beam 11 moves to the position above the flower pots 7, so that the gripped plants 4 are present above a flower pot 7. Subsequently the grippers plant the plants 4 in the flower pots, leave the plants and move backwards to their original position.

The following features are relevant for the present invention.

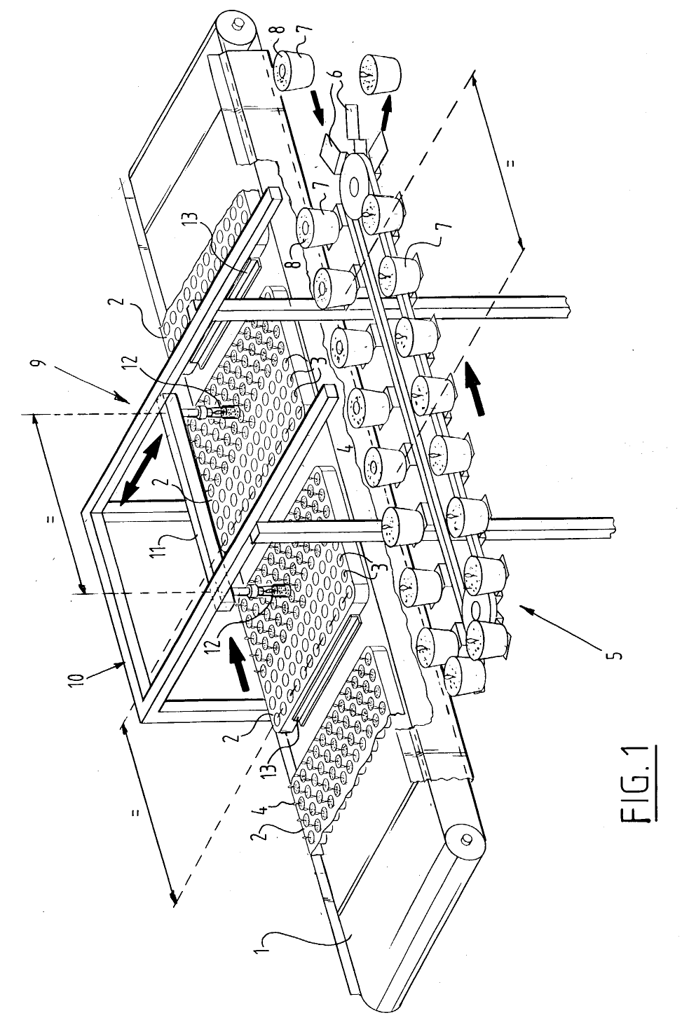

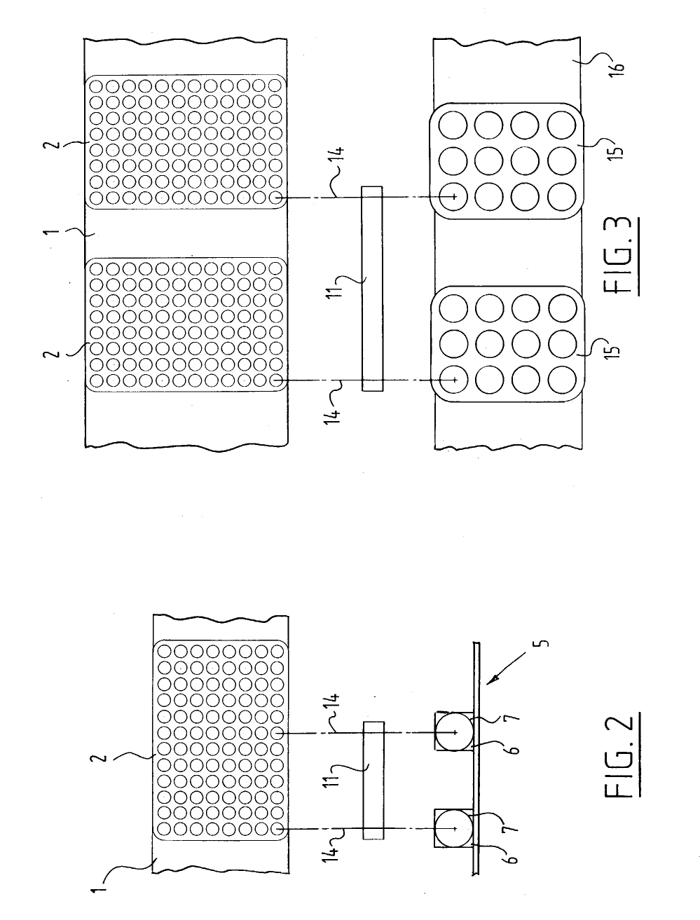

The distance between the two grippers 12 is equal to the pitch between the trays 2 and the pitch between flower pots 7. To the sides of the flower pots, the pitch is determined by the pitch of the clamps 6. To determine the pitch of the trays 2 the conveyor belt 2 is provided with stop elements 13 with a mutual equal distance. It will be clear that other constructions can be applied and that the invention is no way limited to the form of construction shown herein. In FIG. 2 the configuration depicted in FIG. 1 is depicted diagrammically from above. It appears that in this configuration a plant 4 is taken from two different trays which are located in different containers in the shape of different flower pots 7.

A similar configuration can also be used for simultaneously transporting 3 or even more plants per movement of the traverse 11. Such a configuration is depicted in FIG. 3. It is noted that the lines 14 each represent the movement of the plant.

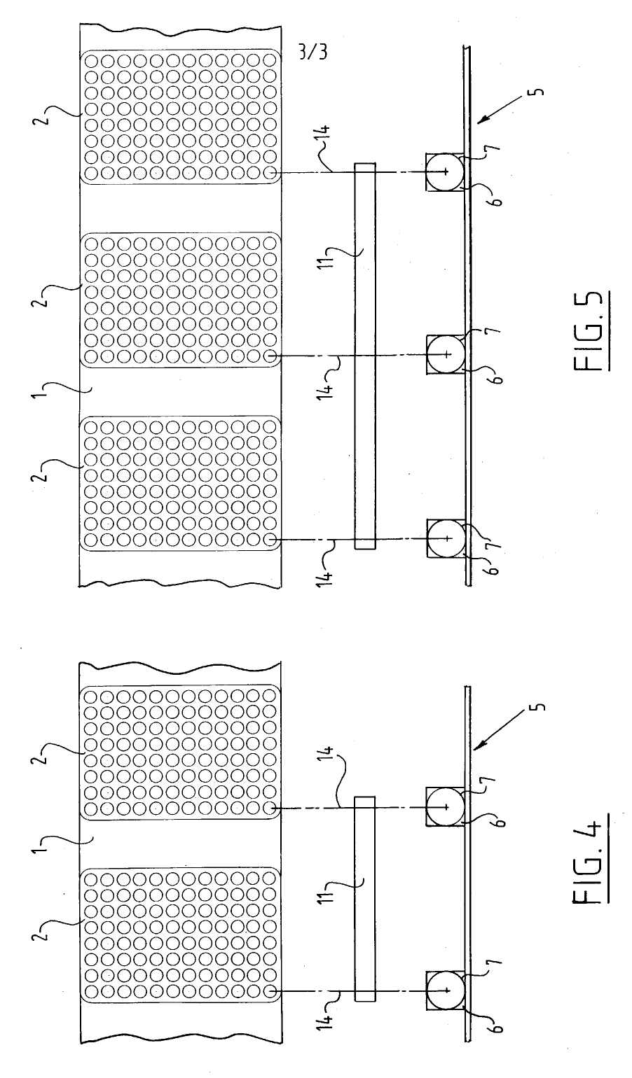

FIG. 4 shows a configuration in which two plants are taken from the same tray 2. This embodiment does not enjoy all advantages of the invention; gripping the plant 4 in the tray by the right hand gripper 12 may cause obstruction by the leaves of surrounding plants. This problem is less at the location of the left hand gripper, as this is on a corner. Also in the other embodiments one starts at a corner of a tray, so that the obstruction by surrounding plants is minimal. During the further emptying of the tray, this disadvantage obviates.

A last embodiment is shown in FIG. 5; herein the plants of trays with little cavities are brought to trays with large cavities.

Although this has not been shown in the drawings, it is possible to change the distance between the grippers during the movement between the containers, so that flexibility is obtained. It will be clear that several embodiments can be mutually varied without deviating from the invention.

1. Apparatus for transplanting plants from containers with small cavities to containers with large cavities, comprising:
first transport means for supplying and removing containers with small cavities;
second transport means for supplying and removing containers with large cavities;
a moving and gripping device with a first movable gripper for gripping the plants in the container with the small cavities, transporting the plant to the containers with the large cavities and locating the plants in the large cavities, characterized in that the moving and gripping device comprises at least a second gripper, wherein the first and the at least second gripper are located on the same carrier, which carrier is movable between a position above the first transport means and a position above the second transport means.

2. Apparatus as claimed in claim 1, characterized in that:
the first transport means have been adapted for supplying containers with small cavities with a first pitch between the containers;
the second transport means have been adapted for supplying containers with large cavities with a second pitch between the containers; and
the distance between the first gripper and the second gripper equals the, first pitch.

3. Apparatus as claimed in claim 1, characterized in that the distance between the first and the second gripper is adaptable.

4. Apparatus as claimed in claim 2, characterized in that the second transport means have been adapted for supplying containers with more than one cavity per container, and that the second transport means have been adapted for supplying containers with one cavity per container.

5. Apparatus as claimed in claim 1, characterized in that the moving and gripping apparatus comprises at least a third gripper, in which the first, second and at least third gripper are located on a line, and in which the distance between the second gripper and the at least third gripper equals the first pitch.

6. Apparatus as claimed in claim 1, characterized in that:
the first transport means are adapted for supplying containers with the small cavities with a first pitch between the cavities;
the second transport means are adapted for supplying containers with a second pitch between the containers; and
the distance between the first and the second gripper equals the second pitch.

7. Apparatus as claimed in claim 6, characterized in that the moving and gripping apparatus comprises at least a third gripper, in which the first, second and at least third gripper are located on a line, and in which the distance between the second gripper and the at least third gripper equals the second pitch.

8. Apparatus as claimed in claim 1, characterized in that:
the direction of transport of both transport means extends mutually parallel;
the carrier comprises a longitudinal element on which the grippers have been located; and
the carrier is movable substantially perpendicular to the direction of transport of the transporting means.

9. Apparatus as claimed in claim 8, characterized in that the apparatus comprises a gantry construction, of which the legs have been located at both sides of the transport means, and wherein the carrier has been movably suspended to the horizontal part of the gantry construction.

10. Apparatus as claimed in claim 1, characterized in that the first and second transport means comprise positioning means for supplying the containers with the correct pitch.

11. Apparatus as claimed in claim 3, characterized in that the second transport mean have been adapted for supplying containers with more than one cavity per container, and that the second transport means have been adapted for supplying containers with one cavity per container.

12. Apparatus as claimed in claim 2, characterized in that:
the direction of transport of both transport means extends mutually parallel;
the carrier comprises a longitudinal element on which the grippers have been located; and
the carrier is movable substantially perpendicular to the direction of transport of the transporting means.

13. Apparatus as claimed in claim 4, characterized in that:
the direction of transport of both transport means extends mutually parallel;
the carrier comprises a longitudinal element on which the grippers have been located; and
the carrier is movable substantially perpendicular to the direction of transport of the transporting means.

14. Apparatus as claimed in claim 5, characterized in that:
the direction of transport of both transport means extends mutually parallel;
the carrier comprises a longitudinal element on which the grippers have been located; and
the carrier is movable substantially perpendicular to the direction of transport of the transporting means.

15. Apparatus as claimed in claim 6, characterized in that:
the direction of transport of both transport means extends mutually parallel;
the carrier comprises a longitudinal element on which the grippers have been located; and
the carrier is movable substantially perpendicular to the direction of transport of the transporting means.

16. Apparatus as claimed in claim 7, characterized in that:
the direction of transport of both transport means extends mutually parallel;
the carrier comprises a longitudinal element on which the grippers have been located; and
the carrier is movable substantially perpendicular to the direction of transport of the transporting means.

17. Apparatus as claimed in claim 2, characterized in that the first and second transport means comprise positioning means for supplying the containers with the correct pitch.

18. Apparatus as claimed in claim 4, characterized in that the first and second transport means comprise positioning means for supplying the containers with the correct pitch.

19. Apparatus as claimed in claim 5, characterized in that the first and second transport means comprise positioning means for supplying the containers with the correct pitch.

20. Apparatus as claimed in claim 8, characterized in that the first and second transport means comprise positioning means for supplying the containers with the corrects pitch.
